(19) United States
(12) Patent Application Publication
(10) Pub. No.: US 2026/0157406 A1
(43) Pub. Date: Jun. 11, 2026

(54) METHOD AND SYSTEM FOR CONTINUOUS PRODUCTION OF PITA CHIPS

(71) Applicant: Regina Ragonesse, Haverhill, MA (US)

(72) Inventor: Regina Ragonesse, Haverhill, MA (US)

(21) Appl. No.: 18/975,191

(22) Filed: Dec. 10, 2024

(51) Int. Cl. A23L 7/13; A21B 1/42; A21D 8/06; A21D 13/42; A21D 13/60; A47J 37/12; B26D 7/32

(52) U.S. Cl. CPC A23L 7/13; A21B 1/42; A21D 8/06; A21D 13/42; A21D 13/60; A47J 37/1214; B26D 7/32; B26D 2210/02

(57) ABSTRACT

The present disclosure teaches a method and system for the industrialized continuous production of pita chips. In state-of-the-art technologies, the front and back sides of the pita bread are separated before the pita bread is diced and fried. In the presently disclosed technology, freshly made, warm pita bread is diced by a dicing machine without its front and back sides being separated. Instead, the front and back sides of diced pita bread are later separated by a vibrating conveyor transporting the diced pita bread to a continuous fryer, which fries the diced pita bread to make pita chips. Pita chips made using the presently disclosed method have curled-up edges, which is a desirable feature for reasons including ease of dipping, a crunchier texture, optimized bite sizes, and a more attractive mouth feel.

### TECHNICAL FIELD

The present disclosure relates to the field of industrial automation for food production.

### BACKGROUND

The state-of-the-art method for producing pita chips includes a step of splitting the front and back pieces of pita bread before dicing the pita bread into smaller chips. The presently disclosed technology eliminates the step of splitting the pita bread before dicing; instead, the diced pita bread goes through a vibrating process to separate the front and back pieces of pita bread.

Further, the state-of-the-art method for producing pita chips also includes a step of cooling down the pita bread. The presently disclosed technology also omits the step of cooling down the pita bread; instead, the warm pita bread directly goes through the process of dicing and frying.

Pita chips produced with the presently disclosed methods have appealing curly edges, whose benefits include ease of dipping, a crunchier texture, optimized bite sizes, and a more attractive mouth feel.

### SUMMARY

The present disclosure relates to a method for continuously producing pita chips, comprising: preparing a plurality of pieces of pita bread, each piece of pita bread being warm from baking, with a front side and a back side, the front side and the back side being disconnected except on edges; dicing the plurality of pieces of pita bread, with a dicing machine, without cooling the plurality of pieces of pita bread first, or separating the front side and the back side of each of the plurality of pieces of pita bread first, resulting in diced pita bread; transporting the diced pita bread on a first conveyor to a continuous fryer; wherein the first conveyor provides vibration able to move the diced pita bread forward, and separate the front side and the back side of the diced pita bread; cooking the diced pita bread with the continuous fryer, resulting in pita chips; transporting the pita chips out of the continuous fryer for further processing with a second conveyor.

In some embodiments, the dicing machine is an Urschel bakery dicer.

In some embodiments, the dicing machine is a FAM dicer.

In some embodiments, the plurality of pieces of pita bread is made from dough made of ingredients including enriched flour, wheat flour, vitamin enrichments, yeast, salt, and water.

In some embodiments, the dough does not include sugar.

In some embodiments, the pita chips include curled-up edges.

In some embodiments, the cooking of the diced pita bread with the continuous fryer takes several minutes.

In some embodiments, the continuous fryer contains cooking oil of approximately 350 Fahrenheit.

In some embodiments, the continuous fryer is an air fryer.

In some embodiments, the continuous fryer includes a third conveyor connected to the first conveyor and the second conveyor.

The presently disclosed technology also teaches an industrial system for continuous production of pita chips, comprising: an continuous oven, to bake a plurality of pieces of pita bread from dough; a dicing machine, to dice the plurality of pieces of pita bread into diced pita bread without cooling the plurality of pieces of pita bread first, or separating the front side and the back side of each of the plurality of pieces of pita bread first; a first conveyor, to transport the diced pita bread to a continuous fryer; wherein the first conveyor provides vibration able to move the diced pita bread forward, and separate the front side and the back side of the diced pita bread; the continuous fryer, to cook the diced pita bread, resulting in pita chips; a second conveyor, to transport the pita chips out of the continuous fryer for further processing.

In some embodiments, the dicing machine is an Urschel bakery dicer.

In some embodiments, the dicing machine is a FAM dicer.

In some embodiments, the dough is made of ingredients including enriched flour, wheat flour, vitamin enrichments, yeast, salt, and water.

In some embodiments, the dough does not include sugar.

In some embodiments, the pita chips include curled-up edges.

In some embodiments, the continuous fryer is configured to cook the diced pita bread for several minutes.

In some embodiments, the continuous fryer contains cooking oil of approximately 350 Fahrenheit.

In some embodiments, the continuous fryer is an air fryer.

In some embodiments, the continuous fryer includes a third conveyor connected to the first conveyor and the second conveyor.

### BRIEF DESCRIPTION OF THE DRAWINGS

The present disclosure is further illustrated by way of exemplary embodiments, which are described in detail through the accompanying drawings. These embodiments are not limiting, and in these embodiments, the same numbering indicates the same structure, wherein:

FIG. 1 is a flow diagram illustrating a method for continuous production of pita chips, according to some embodiments of the presently disclosed technology;

FIG. 2A is an isometric diagram illustrating pita chips produced by state-of-the-art methods; FIG. 2B is an isometric diagram illustrating pita chips produced by the presently disclosed method, according to some embodiments of the presently disclosed technology;

FIG. 3 is a diagram illustrating an industrial system for continuous production of pita chips, according to some embodiments of the presently disclosed technology.

### DETAILED DESCRIPTION

In order to more clearly illustrate the technical solutions of the embodiments of the present disclosure, the accompanying drawings for the description of the embodiments are described below. Obviously, the accompanying drawings in the following description are only some examples or embodiments of the present disclosure, and it is possible for a person of ordinary skill in the art to apply the present disclosure to other similar scenarios in accordance with these accompanying drawings without creative labor. Unless obviously obtained from the context or the context illustrates otherwise, the same numeral in the drawings refers to the same structure or operation.

It should be understood that the terms “system,” “device,” “unit,” and/or “module” are used herein as a way to distinguish between different components, elements, parts, sections, or assemblies at different levels. However, if other words may achieve the same purpose, the terms may be replaced with alternative expressions.

As indicated in the present disclosure and in the claims, unless the context clearly suggests an exception, the words “one,” “a,” “a kind of,” and/or “the” do not refer specifically to the singular but may also include the plural. In general, the terms “include” and “comprise” suggest only the inclusion of clearly identified steps and elements, which do not constitute an exclusive list, and the method or device may also include other steps or elements.

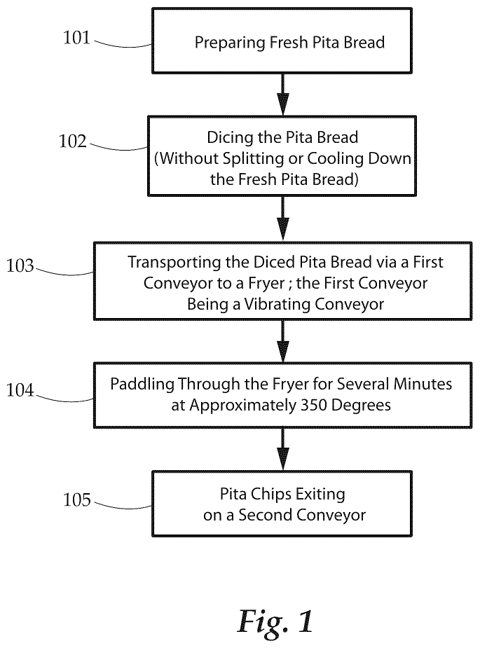

FIG. 1 is a flow diagram illustrating a method for continuous production of pita chips, according to some embodiments of the presently disclosed technology.

At 101, fresh pita bread may be prepared. In some embodiments, steps for preparing fresh pita bread may first include preparing dough made of ingredients including enriched flour, wheat flour, vitamin enrichments, yeast, salt, and water. In some embodiments, the ingredients may not include sugar. In some embodiments, the ingredients may be weighted and measured according to certain proportions and mixed with a large-scale mixer. After the dough is mixed and proportioned, the dough may go through a sheeter and proofing process. For the sheeter process, a machine may be used to roll or flatten the dough into thin even pieces and shape the dough into flat discs. For the proofing process, the dough may rest and rise after shaping, typically in a warm, humid environment. During this time, the yeast in the dough may ferment and produce gas, causing the dough to rise and form the classic “pocket” in pita bread. Then, the dough may be baked in a continuous oven 301 to make fresh pita bread. In some embodiments, the temperature, humidity, and baking time of the continuous oven 301 may be preset and monitored.

In some embodiments, the entire process of preparing fresh pita bread may be streamlined. The method of streamlining the process of preparing pita bread is well-known in the art.

At 102, the pita bread may be diced using a dicing machine 302. In some embodiments, the dicing machine 302 may be an Urschel bakery dicer or FAM dicer. In some embodiments, the dimensions of the dice may be adjusted. As discussed above, freshly baked pita bread has a “pocket” in its middle, separating the pita bread into a front piece and a back piece. The front and back pieces are disconnected but on the edges. As discussed in the background section, in state-of-the-art technologies, the front and back pieces of pita bread are split before the pita bread is diced, and the splitting step may cause the pita bread to be flattened. In the presently disclosed technology, the splitting step is omitted, whose benefits have been briefly discussed in the background section and will be discussed in detail later. In some embodiments, the freshly baked pita bread may not be cooled before being diced. Dicing warm pita bread, instead of cooled-down pita bread, may also aid in splitting the front and back pieces of the pita bread.

At 103, the diced pita bread—which may still be warm—may be transported to a fryer 304 via a first conveyor 303. The first conveyor 303 may be a vibrating conveyor. The first conveyor 303 may be powered by electric motors, pneumatic drives, or electromagnetic actuators that generate vibrations. The vibrations may create a forward motion, moving the diced pita bread along the conveyor bed without direct mechanical pushing. The vibration produced by the first conveyor 303 may also cause the front and back pieces of the diced pita bread to separate, substituting the “splitting” step in state-of-the-art technologies.

At 104, the diced pita bread may be paddled through/in a fryer 304 for a preset amount of time at a preset temperature, resulting in fried pita chips. In some embodiments, the fryer 304 may be a continuous fryer. In a continuous fryer, the pita chips may be placed on a conveyor belt (usually made of heat-resistant, food-safe material) that moves it through the fryer at a controlled speed, ensuring even frying. In some embodiments, the time for frying the diced pita bread may be adjusted by the speed of the conveyor belt. In some embodiments, the conveyor belt in the continuous fryer may connect to the first conveyor, so the pita chips may directly enter the continuous fryer from the first conveyor, without any additional operation by human operators or robotic arms. Hence, the use of a continuous fryer could allow the processing of a large amount of food products with minimal human intervention or assistance from other automated machines. In some embodiments, alternatively, the fryer 304 may be a large-capacity batch fryer. In some embodiments, the loading, frying, and unloading of the pita chips may be automated to ensure efficiency and consistency.

In some embodiments, the fryer 304 may allow precise control of temperature, frying time, and oil filtration for maintaining product quality. In some embodiments, the preset amount of time may be several minutes. In some embodiments, a cooking temperature in the fryer 304 may modulate from 340 to 350 degrees Fahrenheit.

In some embodiments, more than one fryer 304 may be used in series for double-frying or even triple-frying the diced pita bread in oils of different temperatures in different fryers. The diced pita bread may or may not be cooled down before entering a second or third fryer 304. In some embodiments, more than one fryer 304 may be used in parallel or for producing large amounts of pita chips simultaneously with multiple fryers.

In some embodiments, the fryer 304 may be an air fryer, so a minimal amount of oil may be used during the production process.

At 105, the fried pita chips may exit the fryer 304 via a second conveyor 305 for further processing and packaging. In some embodiments, where the fryer 304 is a continuous fryer, the conveyor belt may connect to the second conveyor 305.

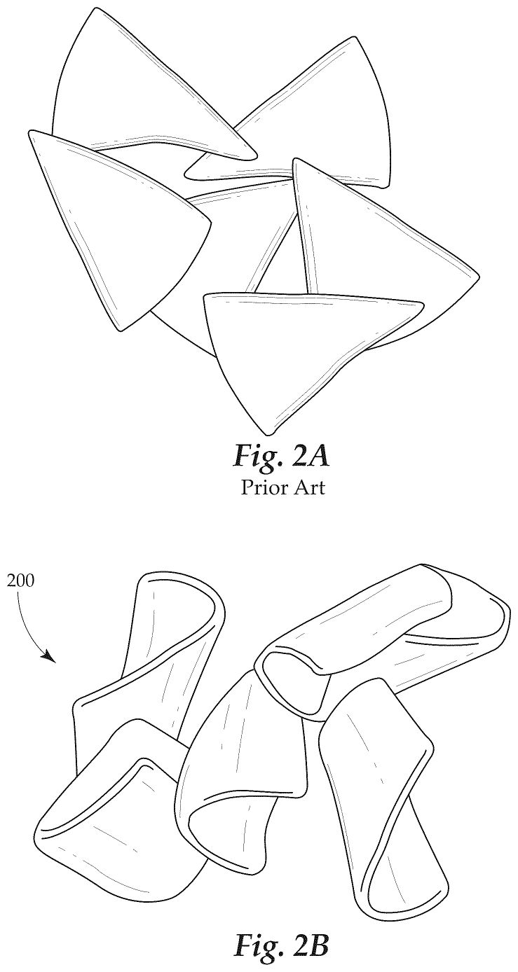

FIG. 2A is an isometric diagram illustrating pita chips produced by state-of-the-art methods; FIG. 2B is an isometric diagram illustrating pita chips produced by the presently disclosed method, according to some embodiments of the presently disclosed technology.

As in FIG. 2A, pita chips produced by state-of-the-art industrial methods tend to be mostly flat, with little or no curled-up edges. FIG. 2B illustrates an exemplary specimen of pita chips 200 produced by the presently disclosed method, according to some embodiments. As shown in FIG. 2B, the pita chips 200 have predominantly curled-up edges, sometimes taking on cylindrical or conical shapes. These curled-up edges are a desirable feature for pita chips for a few reasons, which have been briefly discussed in the background section. First, during a potential seasoning process, possibly after cooking the chips in a continuous fryer, the curled-up edges could allow a greater amount of seasoning powder to adhere to the surface of the pita chips, resulting in a richer flavor. Second, if the customer wishes to dip the pita chips in a sauce before eating, the curled-up edges could also allow a greater amount of sauce to adhere to the surface of the pita chips or be scooped up by the pita chips. Third, the curled-up edges could make the pita chips crunchier, thus having a better mouthfeel. Fourth, pita chips with curled-up edges may have a larger “height” and smaller “width” and/or “length”, resulting in a more desirable bite size.

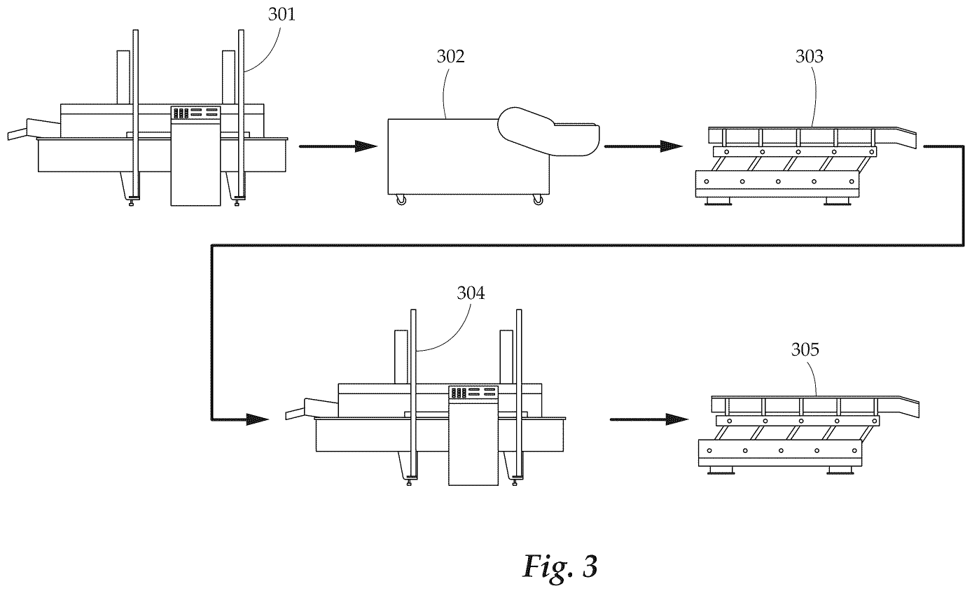

FIG. 3 is a block diagram illustrating an industrial system for the continuous production of pita chips, according to some embodiments of the presently disclosed technology.

As illustrated in FIG. 3, in some embodiments, the presently disclosed system includes an continuous oven 301, to bake the dough into freshly made pita bread after the dough has been sheeter-and-proofed. In some embodiments, the temperature, humidity, and baking time of the continuous oven 301 may be preset and monitored.

In some embodiments, the presently disclosed system may further include a dicing machine 302 to dice the pita bread into small pieces. In some embodiments, the freshly made pita bread may not be cooled down or had its front and back surfaces split before getting diced into pieces. In some embodiments, the dicing machine 302 may be an Urschel bakery or FAM dicer.

In some embodiments, the presently disclosed system may further include a first conveyor 303, to transport the diced pita bread from the dicing machine 302 to the fryer 304. As discussed above, the first conveyor 303 may be a vibrating conveyor. Besides transporting the pita chips, the vibration of the first conveyor 303 may also serve the purpose of splitting the front and back surfaces of the diced pita bread.

In some embodiments, the presently disclosed system may further include a fryer 304, to fry the diced pita bread to produce pita chips at a preset temperature for a preset amount of time. As discussed above, the fryer 304 may be a continuous fryer or a large-capacity batch fryer. In some embodiments, the fryer 304 may also be an air fryer. In some embodiments, more than one fryer 304 may be used in series or parallel.

In some embodiments, the presently disclosed system may further include a second conveyor 305, for pita chips to exit the fryer 304 for further processing and packaging.

In some embodiments, the presently disclosed method and system may handle a production size of at least 19,000 lbs.

Furthermore, unless explicitly stated in the claims, the use of order, numbers, letters, or other names for processing elements and sequences is not intended to limit the order of the processes and methods of the present disclosure. While various examples have been discussed in the disclosure as currently considered useful embodiments of the invention, it should be understood that such details are provided for illustrative purposes only. The appended claims are not limited to the disclosed embodiments, and instead, the claims are intended to cover all modifications and equivalent combinations within the scope and essence of the embodiments disclosed in the present disclosure. For example, although the described system components may be implemented through a hardware device, they may also be realized solely through a software solution, such as installing the described system on an existing processing or mobile device.

Similarly, it should be noted that, for the sake of simplifying the presentation of embodiments disclosed in the present disclosure and aiding in understanding one or more embodiments of the present disclosure, various features have been sometimes combined into a single embodiment, drawing, or description. However, this manner of disclosure does not imply that the features required by the claims are more than the features mentioned in the claims. In fact, the features of the embodiments are less than all the features of the single embodiment disclosed in the foregoing disclosure.

In some embodiments, numeric values describing the composition and quantity of attributes are used in the description. It should be understood that such numeric values used for describing embodiments may be modified with qualifying terms such as “about,” “approximately” or “generally”. Unless otherwise stated, “about,” “approximately” or “generally” indicates that a variation of ±20% is permitted in the described numbers. Accordingly, in some embodiments, the numerical parameters used in the disclosure and claims are approximations, which can change depending on the desired characteristics of the individual embodiment. In some embodiments, the numerical parameters should take into account a specified number of valid digits and employ a general manner of bit retention. Although the numerical ranges and parameters used in some embodiments of the present disclosure to confirm the breadth of the range are approximations, in specific embodiments, such numerical values are set as precisely as practicable.

With respect to each of the patents, patent applications, publications of patent applications, and other material, such as articles, books, specifications, publications, documents and the like, cited in the present disclosure, the entire contents thereof are hereby incorporated herein by reference. Application history documents that are inconsistent with the contents of the present disclosure or that create conflicts are excluded, as are documents (currently or hereafter appended to the present disclosure) that limit the broadest scope of the claims of the present disclosure. It should be noted that in the event of any inconsistency or conflict between the descriptions, definitions, and/or use of terminology in the materials appended to the present disclosure and the contents described herein, the descriptions, definitions, and/or use of terminology in the present disclosure shall prevail.

In closing, it should be understood that the embodiments described in the present disclosure are used only to illustrate the principles of the embodiments of the present disclosure. Other deformations may also fall within the scope of the present disclosure. Therefore, by way of example and not limitation, alternative configurations of the embodiments disclosed in the present disclosure may be considered consistent with the teachings of the present disclosure. Accordingly, the embodiments described in the present disclosure are not limited to the explicitly introduced and described embodiments in the present disclosure.

What is claimed is:

1. A method for continuously producing pita chips, comprising:
baking, by an continuous oven, a plurality of pieces of pita bread, each piece of pita bread being warm from the baking, with a front side and a back side, the front side and the back side being disconnected except on edges;
dicing, by a dicing machine, the plurality of pieces of pita bread without cooling the plurality of pieces of pita bread first, or separating the front side and the back side of each of the plurality of pieces of pita bread first, resulting in diced pita bread;
transporting, by a first conveyor, the diced pita bread to a continuous fryer;
wherein the first conveyor provides vibration able to move the diced pita bread forward, and separate the front side and the back side of the diced pita bread;
cooking, by the continuous fryer, the diced pita bread, resulting in pita chips;
transporting, by a second conveyor, the pita chips out of the continuous fryer for further processing.

2. The method of claim 1, wherein the dicing machine is an Urschel bakery dicer.

3. The method of claim 1, wherein the dicing machine is a FAM dicer.

4. The method of claim 1, wherein the plurality of pieces of pita bread is made from dough made of ingredients including enriched flour, wheat flour, vitamin enrichments, yeast, salt, and water.

5. The method of claim 4, wherein the dough does not include sugar.

6. The method of claim 1, wherein the pita chips include curled-up edges.

7. The method of claim 1, wherein the cooking of the diced pita bread with the continuous fryer takes several minutes.

8. The method of claim 1, wherein a cooking temperature in the continuous fryer modulates from 340 to 350 degrees Fahrenheit.

9. The method of claim 1, wherein the continuous fryer is an air fryer.

10. The method of claim 1, wherein the continuous fryer includes a third conveyor connected to the first conveyor and the second conveyor.

11. An industrial system for continuous production of pita chips, comprising:
an continuous oven, to bake a plurality of pieces of pita bread from dough;
a dicing machine, to dice the plurality of pieces of pita bread into diced pita bread without cooling the plurality of pieces of pita bread first, or separating the front side and the back side of each of the plurality of pieces of pita bread first;
a first conveyor, to transport the diced pita bread to a continuous fryer;
wherein the first conveyor provides vibration able to move the diced pita bread forward, and separate the front side and the back side of the diced pita bread;
the continuous fryer, to cook the diced pita bread, resulting in pita chips;
a second conveyor, to transport the pita chips out of the continuous fryer for further processing.

12. The industrial system of claim 11, wherein the dicing machine is an Urschel bakery dicer.

13. The industrial system of claim 11, wherein the dicing machine is a FAM dicer.

14. The industrial system of claim 11, wherein the dough is made of ingredients including enriched flour, wheat flour, vitamin enrichments, yeast, salt, and water.

15. The industrial system of claim 14, wherein the dough does not include sugar.

16. The industrial system of claim 11, wherein the pita chips include curled-up edges.

17. The industrial system of claim 11, wherein the continuous fryer is configured to cook the diced pita bread for several minutes.

18. The industrial system of claim 11, wherein the continuous fryer contains cooking oil of approximately 350 Fahrenheit.

19. The industrial system of claim 11, wherein the continuous fryer is an air fryer.

20. The industrial system of claim 11, wherein the continuous fryer includes a third conveyor connected to the first conveyor and the second conveyor.
